(19) United States
(12) Patent Application Publication
(10) Pub. No.: US 2021/0237230 A1
(43) Pub. Date: Aug. 5, 2021

(54) TOOL FOR REMOVING ARTICLES FROM A DRAIN

(71) Applicant: Mary Somerville, Norlina, NC (US)

(72) Inventor: Mary Somerville, Norlina, NC (US)

(21) Appl. No.: 16/781,044

(22) Filed: Feb. 4, 2020

(51) Int. Cl. B25B 9/00; E03C 1/302; B25J 1/04; B25B 11/00

(52) U.S. Cl. CPC B25B 9/00; B25B 11/002; B25J 1/04; E03C 1/302

(57) ABSTRACT

A tool for removing articles from a drain includes a rod that has a first end, a second end and a peripheral surface extending between the first and second ends. A hook is attached to and extends away from the first end of the rod. A magnet is attached to the second end of the rod.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to drain accessing tool devices and more particularly pertains to a new drain accessing tool device for facilitating the removal of items from a drain.

### BRIEF SUMMARY OF THE INVENTION

An embodiment of the disclosure meets the needs presented above by generally comprising a rod that has a first end, a second end and a peripheral surface extending between the first and second ends. A hook is attached to and extends away from the first end of the rod. A magnet is attached to the second end of the rod.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a tool for removing articles from a drain according to an embodiment of the disclosure.

FIG. 2 is a top view of an embodiment of the disclosure.

FIG. 3 is a side view of an embodiment of the disclosure.

FIG. 4 is a top view of an embodiment of the disclosure.

FIG. 5 is an in-use, broken isometric view of an embodiment of the disclosure.

### DETAILED DESCRIPTION OF THE INVENTION

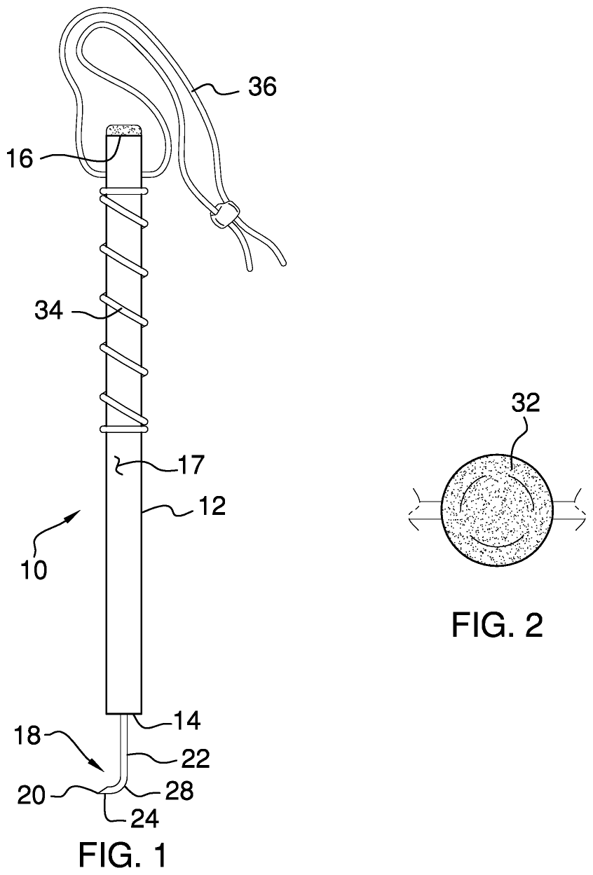

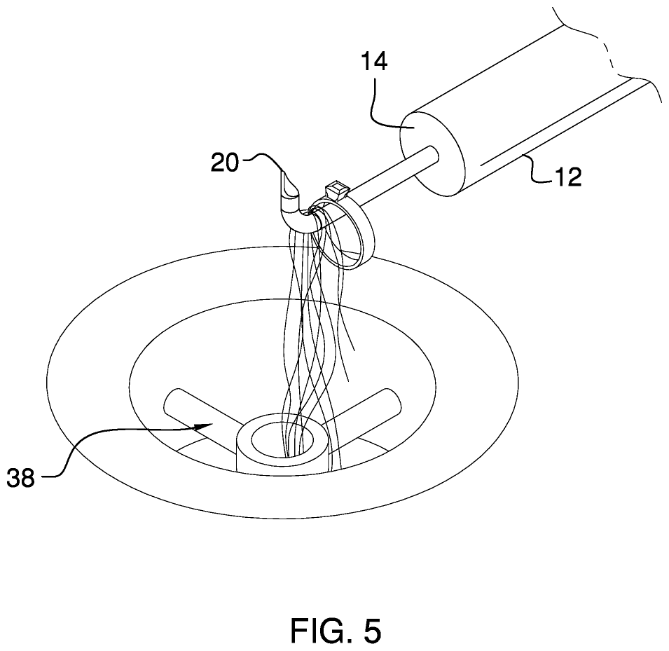

With reference now to the drawings, and in particular to FIGS. 1 through 5 thereof, a new drain accessing tool device embodying the principles and concepts of an embodiment of the disclosure and generally designated by the reference numeral 10 will be described.

As best illustrated in FIGS. 1 through 5, the tool 10 for removing articles from a drain generally comprises a rod 12 that has a first end 14, a second end 16 and a peripheral surface 17 extending between the first 14 and second 16 ends. The rod 12 is comprised of a rigid material and be formed of plastic, wood, metal or other rigid materials. The rod 12 has a length from the first end 14 to the second end 16 generally between 6.0 inches and 10.0 inches. The rod 12 may have a cylindrical shape and a diameter that is less than 0.5 inches.

A hook 18 is attached to and extends away from the first end 14 of the rod 12. The hook 18 has a free end 20 and includes a first portion 22 and a second portion 24 wherein the second portion 24 includes the free end 20. A juncture of the first 22 and second 24 portions comprises a bend 28. As can be seen in FIG. 1, the first portion 22 may be co-linear with a longitudinal axis of the rod 12 extending through the first 14 and second 16 ends. In this embodiment, the first portion 22 may be orientated perpendicular to the second portion 24. The free end 20 may be pointed to allow the free end 20 to puncture an object being engaged with the tool 10 or to scrape a surface. The second portion 24 has a length from the bend 28 to the free end 20 that is less than 1.0 inches.

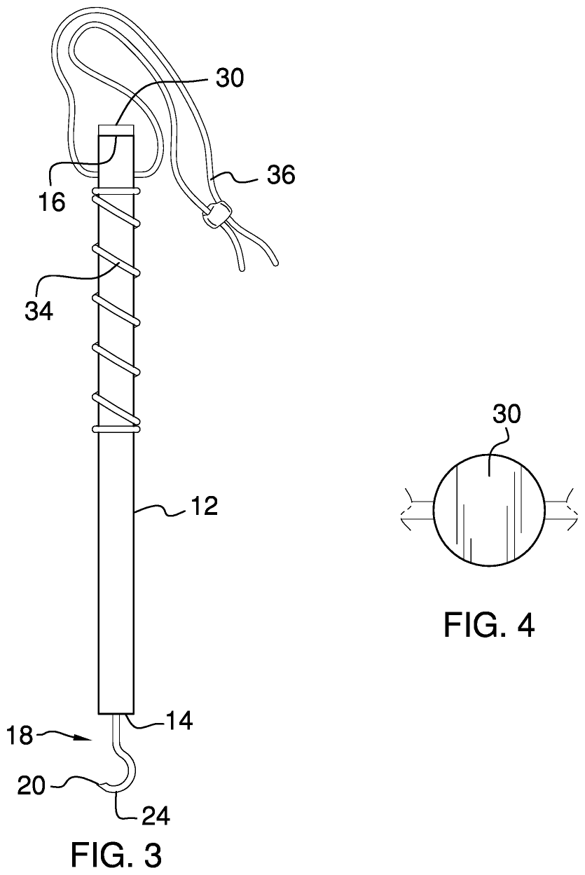

As can be seen in FIG. 3, the second portion 24 of the hook 18 may be arcuate. The arcuate shape assists a person in hooking articles such as rings, hair and like lift such from a drain. It should be understood that when the term “drain” herein is utilized, it is done so with particular attention to the areas adjacent to an entry point of the drain, i.e. where the pipe intersects the bottom of a sink, such as adjacent to a drain stopper and hair catch as opposed to the drain water trap further down a drain pipe. Though the tool 10 could be used for reaching to the water trap, the tool 10 is more tailored for preventing the loss of articles down the drain and for hair removal before it enters the trap.

A magnet 30 may be attached to the second end 16 of the rod 12. The magnet 30 is used to magnetically attract objects which are magnetically active so that they may be pulled out of drains or other areas. As can be seen in FIG. 2, a compressible material 32 may be attached to the second end 16 for allowing a person to use the second end 16 for cleaning a surface.

A grip 34 is attached to the rod 12 and is positioned adjacent to the second end 16. The grip 34 comprises a raised member attached to and extending around the peripheral surface 17. The grip 34 may be formed in a helical pattern. The grip 34 may comprise a plastic material or an elastomeric material. The grip 34 may be comprised of a tacky material and/or compressible material to assist a person in holding onto the rod 12. To further facilitate retaining a grip 34 on the rod 12, a tether 36 may be attached to the rod 12 adjacent to the second end 16.

In use, the tool 10 is used to remove articles before they are fully lost down a drain 38 and more specifically before they reach the water trap. The articles may comprise, for example, rings, earrings, or other personal items. Additionally, the tool 10 may be used for removing hair and items before clogging of the drain 38 or reducing its ability to drain properly.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An object retrieval tool assembly configured to remove articles from a drain, the assembly comprising:
a rod having a first end, a second end and a peripheral surface extending between the first and second ends;
a hook being attached to and extending away from the first end of the rod; and
a magnet being attached to the second end of the rod.

2. The object retrieval tool assembly according to claim 1, wherein the rod has a length from the first end to the second end generally between 6.0 inches and 10.0 inches.

3. The object retrieval tool assembly according to claim 2, wherein the rod has a cylindrical shape and has a diameter being less than 0.5 inches.

4. The object retrieval tool assembly according to claim 1, wherein the hook has a free end, the hook including a first portion and a second portion wherein the second portion includes the free end, a juncture of the first and second portions comprising a bend, the free end being pointed.

5. The object retrieval tool assembly according to claim 4, wherein the first and second portions are orientated perpendicular to each other.

6. The object retrieval tool assembly according to claim 5, wherein the first portion is co-linear with a longitudinal axis of the rod extending through the first and second ends.

7. The object retrieval tool assembly according to claim 6, wherein the second portion has a length from the bend to the free end being less than 1.0 inches.

8. The object retrieval tool assembly according to claim 1, further including a grip being attached to the rod and being positioned adjacent to the second end.

9. The object retrieval tool assembly according to claim 8, wherein the grip comprises a raised member attached to and extending around the peripheral surface in a helical pattern.

10. The object retrieval tool assembly according to claim 9, wherein the grip comprises a plastic material or an elastomeric material.

11. The object retrieval tool assembly according to claim 1, further including a tether being attached to the rod adjacent to the second end.

12. An object retrieval tool assembly configured to remove articles from a drain, the assembly comprising:
a rod having a first end, a second end and a peripheral surface extending between the first and second ends, the rod having a length from the first end to the second end generally between 6.0 inches and 10.0 inches, the rod having a cylindrical shape and having a diameter being less than 0.5 inches;
a hook being attached to and extending away from the first end of the rod, the hook having a free end, the hook including a first portion and a second portion wherein the second portion includes the free end, a juncture of the first and second portions comprising a bend, the free end being pointed, the first and second portions being orientated perpendicular to each other, the first portion being co-linear with a longitudinal axis of the rod extending through the first and second ends, the second portion having a length from the bend to the free end being less than 1.0 inches;
a magnet being attached to the second end of the rod;
a grip being attached to the rod and being positioned adjacent to the second end, the grip comprising a raised member attached to and extending around the peripheral surface in a helical pattern, the grip comprising a plastic material or an elastomeric material; and
a tether being attached to the rod adjacent to the second end.
